(19) United States
(12) Patent Application Publication
(10) Pub. No.: US 2006/0112764 A1
(43) Pub. Date: Jun. 1, 2006

(54) Angular velocity detector having inertial mass oscillating in rotational direction

(75) Inventor: Hirofumi Higuchi, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/239,084

(22) Filed: Sep. 30, 2005

(30) Foreign Application Priority Data
Dec. 1, 2004 (JP) 2004-348543

(51) Int. Cl. G01P 9/04

(52) U.S. Cl. 73/504.12; 73/504.13

(57) ABSTRACT

An angular velocity detector includes a disk-shaped inertial mass supported on a substrate via driving beams and a second mass connected to the inertial mass via detecting beams. The inertial mass is oscillated in its rotational direction around a center axis (z) by an electrostatic force. When an angular velocity around a detection axis (x), which is perpendicular to the center axis (z), is imposed on the second mass while the inertial mass is oscillating, the second mass displaces in the direction parallel to the center axis (z). A capacitance between the second mass and the substrate changes according to the displacement of the second mass. The angular velocity is detected based on the changes in the capacitance. Since the driving beams allow the inertial mass to oscillate only in the rotational direction, the driving beams can be easily designed and manufactured.

### CROSS-REFERENCE TO RELATED APPLICATION

This application is based upon and claims benefit of priority of Japanese Patent Application No. 2004-348543 filed on Dec. 1, 2004, the content of which is incorporated herein by reference.

### BACKGROUND OF THE INVENTION

1. Field of the Invention

The present invention relates to an angular velocity detector having an inertial mass oscillating in its rotational direction.

2. Description of Related Art

The angular velocity detector of this type detects an angular velocity imposed around a detection axis that is perpendicular to a rotational axis of an inertial mass. The inertial mass is displaced by Coriolis force imposed on the inertial mass when the inertial mass is oscillating around its rotational center. An example of the angular velocity detector of this type is disclosed in JP-A-2001-99855.

There is another type of the angular velocity detector using the Coriolis force, in which an inertial mass vibrates along a straight line. In the angular velocity detector of this type, the inertial mass is displaced by an angular velocity in a direction perpendicular to the straight line along which the inertial mass is vibrating. In this type of the detector, however, an angular velocity is falsely detected when linear acceleration is imposed in the detection direction even if there is no angular velocity. To cancel the falsely detected linear acceleration, two inertial masses vibrating with opposite phases are used. However, it is unavoidable to make the structure of the angular velocity detector complex.

As opposed to the angular velocity detector having the inertial masses vibrating along the straight line, the detector having the inertial mass vibrating around its rotational center does not require any means for canceling the linear acceleration. The essential structure of a conventional detector having the inertial mass vibrating around the rotational center is shown in FIGS. 3A and 3B attached hereto. The angular velocity detector J100 includes an inertial mass 30 supported on a substrate 10. The inertial mass 30 oscillates around a center axis z which is perpendicular to a plane of the substrate 10.

The angular velocity detector J100 is manufactured by etching a three-layer semiconductor plate composed of a substrate 10, a sacrifice layer 11 and a semiconductor layer 12, laminated in this order. A disc-shaped inertial mass 30, driving beams 40, driving electrodes 60, 61 and other components shown in FIG. 3A are formed by patterning the semiconductor layer 12. Then, the inertial mass 30 is separated from the substrate 10 by partially removing the sacrifice layer 11. The inertial mass 30 is resiliently connected to a support 20 made of the sacrifice layer 11 via driving beams 40. The driving beams 40 are so made that the inertial mass 30 is able to oscillate around the center axis z and is able to deform in the direction parallel to the center axis z when an angular velocity Ωx is imposed around a detection axis x that is parallel to the plane of the substrate 10 and perpendicular to the center axis z.

The driving electrodes 60, 61 for oscillating the inertial mass 30 around the center axis z are fixed to the substrate 10 via the sacrifice layer 11. Driving signals having opposite alternating current phases are supplied to the first driving electrodes 60 and the second driving electrodes 61, respectively, so that inertial mass 30 oscillates around the center axis z. Each driving electrode 60, 61 is connected to stationary electrodes 60a, 61a that face movable electrodes 31a connected to the inertial mass 30. Upon supplying driving power to the driving electrodes 60, 61, the inertial mass 30 oscillates back and force around the center axis z by electrostatic force between the stationary electrodes 60a, 61a and the movable electrodes 31a, as shown with an arrow in FIG. 3A. To obtain a higher oscillating force from a smaller driving power, a resonant frequency of the inertial mass 30 is made to coincide with the frequency of the driving power. The resonant frequency of the inertial mass 30 is determined by a Young's modulus of the driving beams 40 and the mass of the inertial mass 30.

When an angular velocity Ωx is imposed around the detection axis x during a period in which the inertial mass 30 is oscillating, outer peripheral portions of the inertial mass 30 is deformed in the direction perpendicular to the plane of the substrate 10 (in the direction parallel to the center axis z) by the Coriolis force, as shown in FIG. 3B. Therefore, a distance (a capacitance) between the outer peripheral portions of the inertial mass 30 and detection electrodes 70 formed on the substrate 10 changes according to the angular velocity Ωx. The angular velocity Ωx is detected based on the capacitance between the detection electrodes 70 and the outer peripheral portions of the inertial mass 30.

Since the angular velocity is detected, in the conventional detector J100 described above, based on the amount of deformation of the inertial mass 30 in the direction perpendicular to the plane of the substrate 10, the driving beams 40 have to be made to allow the inertial mass 30 to move in both directions, i.e., in the rotational direction and in the axial is direction (in the direction of the center axis z). Therefore, the driving beams 40 have to be carefully designed and manufactured, taking into consideration the resonant frequencies in the rotational direction and in the axial direction. It is particularly difficult to make the driving beams 40 in precise dimensions that realize desired resonant frequencies in both directions.

### SUMMARY OF THE INVENTION

The present invention has been made in view of the above-mentioned problem, and an object of the present invention is to provide an improved angular velocity detector having driving beams that can be easily designed and manufactured.

The angular velocity detector is mainly composed of a disk-shaped inertial mass supported on a substrate via driving beams and a second mass connected to the inertial mass via detecting beams. The inertial mass is oscillated in its rotational direction around a center axis (z) by electrostatic force applied thereto. The driving beams are resilient to allow the oscillation of the inertial mass only in the rotational direction. The detecting beams connecting the second mass to the inertial mass are resilient to allow the second mass to displace only in the axial direction which is perpendicular to the plane of the inertial mass and parallel to the center axis (z).

The angular velocity detector is manufactured from a three-layer plate composed of a substrate, a sacrifice layer and a semiconductor layer, all laminated in this order. The disk-shaped inertial mass is separated from the substrate to be supported on the substrate only by the driving beams by removing the sacrifice layer by etching. The driving beams, the second mass and the detecting beams are also patterned from the semiconductor layer by etching.

When an angular velocity is imposed around a detection axis (x) which is parallel to the plane of the inertial mass and perpendicular to the center axis (z), while the inertial mass is oscillating back and forth around the center axis (z), the second mass connected to the inertial mass via the detecting beams displaces in the direction parallel to the center axis (z). A capacitance formed between the second mass and a detection electrode formed on the substrate changes according to the displacement of the second mass. The angular velocity around the detection axis (x) is detected based on the changes in the capacitance.

A pair of the second masses may be positioned symmetrically with respect to the center axis (z) to cancel any acceleration components imposed in the direction of the center axis (z) from the detected angular velocity around the detection axis (x). The cancellation of the acceleration components is realized by taking a displacement difference between the pair of the second masses. Two pairs of the second masses may be used so that an angular velocity around the detection axis (x) is detected by one pair and another angular velocity around the axis (y), which is perpendicular to the detection axis (x), is detected by the other pair.

In the angular velocity detector of the present invention, the driving beams connecting the inertial mass to the substrate allow oscillation of the inertial mass only in its rotational direction, while the detecting beams connecting the second mass to the inertial mass allow the second mass to displace only in the axial direction. Therefore, the both beams are easily designed and manufactured without being restricted by various factors. Other objects and features of the present invention will become more readily apparent from a better understanding of the preferred embodiments described below with reference to the following drawings.

### BRIEF DESCRIPTION OF THE DRAWINGS

FIG. 1A is a plan view showing an angular velocity detector as a first embodiment of the present invention;

FIG. 1B is a cross-sectional view showing the angular velocity detector along line IB-IB shown in FIG. 1A;

FIG. 2A is a plan view showing an angular velocity detector as a second embodiment of the present invention;

FIG. 2B is a cross-sectional view showing the angular velocity detector along line IIB-IIB shown in FIG. 2A;

FIG. 3A is a plan view showing a conventional angular velocity detector; and

FIG. 3B is a cross-sectional view showing the conventional angular velocity detector along line IIIB-IIIB shown in FIG. 3A.

### DETAILED DESCRIPTION OF THE PREFERRED EMBODIMENTS

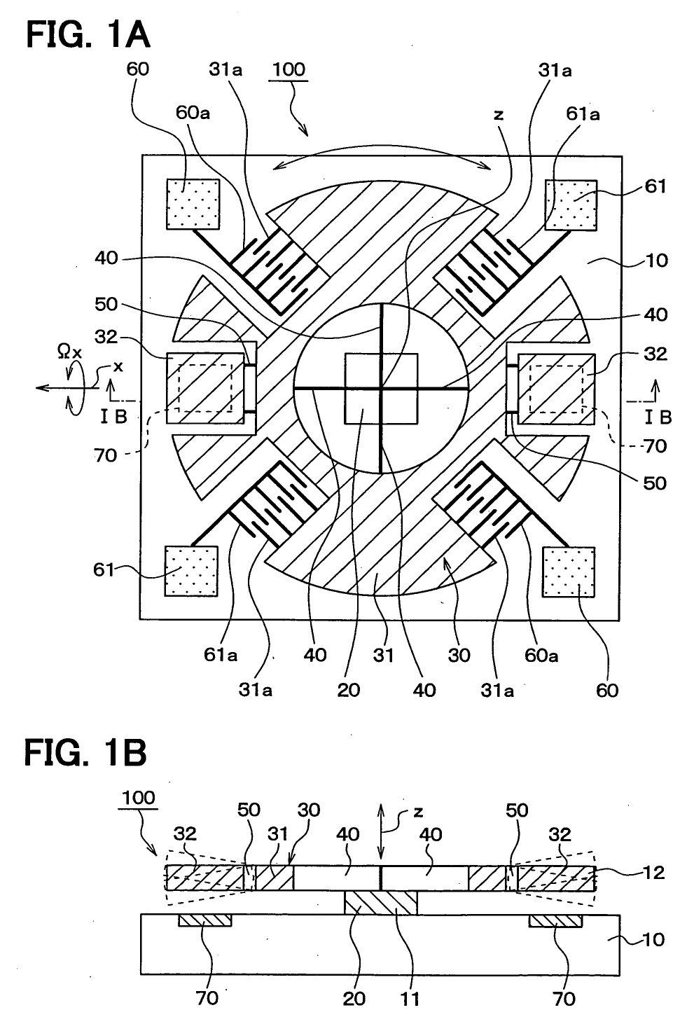

A first embodiment of the present invention will be described with reference to FIGS. 1A and 1B showing a plan view and a cross-sectional view of an angular velocity detector 100 of the present invention, respectively. Hatching in FIG. 1A does not mean a cross-section but shows a top plane of components. In order to clearly differentiate an inertial mass 30 from driving electrodes 60, 61, the former is hatched and the latter is dotted.

The angular velocity detector 100 is manufactured from a three-layer plate composed of a substrate 10, a sacrifice layer 11 such as a silicon oxide layer and a semiconductor layer 12 such as an epitaxial poly-silicone layer, laminated in this order. The detector 100 is manufactured by known semiconductor processing technologies. Portions of the sacrifice layer 11 are removed by etching to separate an inertial mass 30 from the substrate 10. Alternatively, the angular velocity detector 100 may be manufactured from a silicon-on-insulator substrate (SOI). In the case of SOI, it is preferable to make the top semiconductor layer highly conductive by diffusing impurities.

The angular velocity detector 100 is used, for example, as a device mounted on an automobile, such as a yaw rate sensor, a roll rate sensor or a pitch rate sensor. To use the angular velocity detector 100 as the yaw rate sensor, it is mounted on the vehicle so that the plane of the substrate 10 becomes vertical. To use it as the roll rate or the pitch rate sensor, the plane of the substrate 10 is positioned to be horizontal.

The angular velocity detector 100 is made from the three-layer plate in the following manner, for example. First, components such as an inertial mass 30, driving beams 40, detecting beams 50 and driving electrodes 60, 61 are patterned on the semiconductor layer 12 by etching. Then, a support 20 is formed on the substrate 10 by removing portions of the sacrifice layer 11 by etching.

The support 20 made of the sacrifice layer 11 is fixed on the substrate 10, and the inertial mass 30 is supported on the support 20 via four driving beams 40. The support 20 is square-shaped and positioned at a center of the substrate 10. One end of the driving beams 40 is fixed to the support 20 and the other end thereof is connected to an inner diameter of the inertial mass 30. The driving beams 40 are resilient so that the inertial mass 30 is able to rotate or oscillate around a center axis z that is perpendicular to the plane of the substrate 10. The driving beams 40 allow the inertial mass 30 to move substantially only in the rotational direction and do not allow the inertial mass 30 to move in the axial direction, i.e., in the direction parallel to the center axis z.

The inertial mass 30 is shaped in a disk having a center hole where the driving beams 40 are positioned. The inertial mass 30 is composed of a first mass 31 and a pair of second masses 32 that are positioned, symmetrically with respect to the center axis z, in cutout portions of the first mass 31, as shown in FIG. 1A. By placing the second masses 32 in the cutout portions of the first mass 31, it is avoided to increase the size of the detector 100. The second mass 32 is connected to the first mass 31 via detecting beams 50 which are resiliently deformable substantially only in the axial direction. The inertial mass 30 as a whole, including the first mass 31 and the pair of second masses 32, is able to oscillate around the center axis z, while only the second masses 32 are able to displace in the axial direction.

To oscillate the inertial mass 30 in the rotational direction around the center axis z, movable electrodes 31a are connected to the first mass 31 at its four positions as shown in FIG. 1A. Stationary electrodes 60a connected to the first driving electrode 60 and stationary electrodes 61a connected to the second driving electrode 61 are formed to face the movable electrodes 31a. Electric power having alternating current components in opposite phases is supplied to the first driving electrode 60 and the second electrode 61, respectively, to cause the oscillating motion in the inertial mass 30 around center axis z. The inertial mass 30 is oscillated in the rotational direction by electrostatic force between the movable electrodes 31a and the stationary electrodes 60a, 61a. Preferably, the frequency of the driving power is set to coincide with a resonant frequency of the inertial mass 30 to minimize the driving power. A resonant frequency of the second mass 32 is, of course, different from that of the inertial mass 30.

A pair of detection electrodes 70 is formed on the substrate 10 at positions facing the second masses 32. A capacitor is formed between the detection electrode 70 and the second mass 32. When the second mass 32 displaces in the axial direction, as shown in FIG. 1B with dotted lines, a capacitance of the capacitor changes. The detecting electrodes 70 are connected to a circuit (not shown) for detecting changes in the capacitance. The driving electrodes 60, 61 are connected to a power source for supplying the driving power. These detecting circuit and the power source circuit may be formed on a chip different from the angular velocity detector 100. Alternatively, these circuits may be formed on the same chip on which the angular velocity detector 100 is formed.

Now, operation of the angular velocity detector 100 will be described. A first driving power having alternating current elements is supplied to the first driving electrode 60, and a second driving power having alternating current elements in a phase opposite to that of the first driving power is supplied to the second driving electrode 61. The inertial mass 30 is oscillated back and force, as shown in FIG. 1A with an arrow, around the center axis z by electrostatic force between the stationary electrodes 60a, 61a and the movable electrodes 31a.

If an angular velocity Ωx around the detection axis x, which is parallel to the plane of the substrate 10 and perpendicular to the center axis z, is imposed on the angular velocity detector 100, while the inertial mass 30 is oscillating around the center axis z, the second masses 32 displace in the direction parallel to the center axis z by the Coriolis force. The capacitance between the second mass 32 and the detection electrode 70 changes according to the angular velocity Ωx. By detecting the changes in the capacitance, the angular velocity Ωx is detected. In this embodiment, two second masses 32 are positioned symmetrically with respect to the center axis z, and both second masses 32 displace in opposite directions to each other. Therefore, in this embodiment, the amount of the angular velocity Ωx is detected based on a difference between outputs from both detection electrodes 70.

Advantages attained in the first embodiment described above will be summarized below. Since the inertial mass 30 including the first mass 31 and the second masses 32 oscillates in the rotational direction while the second masses 32 displace in the axial direction (in the direction perpendicular to the plane of the substrate 10), the detecting beams 50 are designed and manufactured, independently from the driving beams 40, so that they deform only in the axial direction. On the other hand, the driving beams 40 are designed and manufactured so that they oscillate only in the rotational direction. Therefore, the driving beams 40 and the detecting beams 50 can be easily designed and manufactured. In particular, it is not required to make the beams 40, 50 to have very precise dimensions.

Since the driving beams 40 are designed not to vibrate in the axial direction (the direction parallel to the center axis z), the oscillation in the rotational direction does not leak to the detecting signal in the axial direction. Therefore, detection accuracy of the angular velocity detector can be improved. Since two second masses 32 are provided symmetrically with respected to the center axis z, output signals due to linear acceleration in the center axis z direction are canceled between two second masses 32. Therefore, the angular velocity Ωx can be surely separated from the linear acceleration.

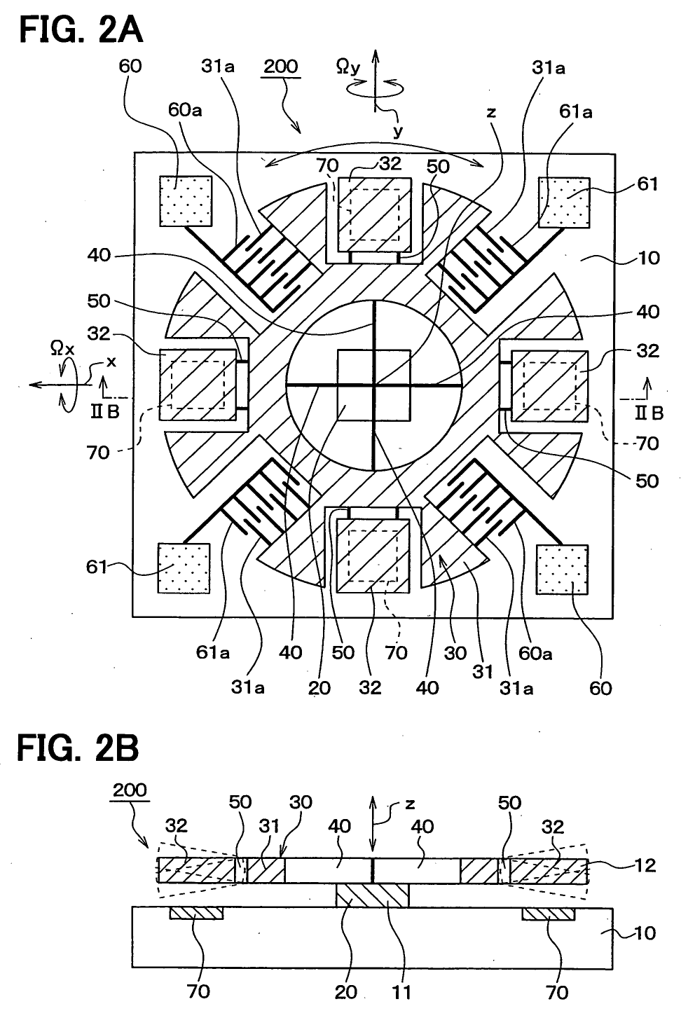

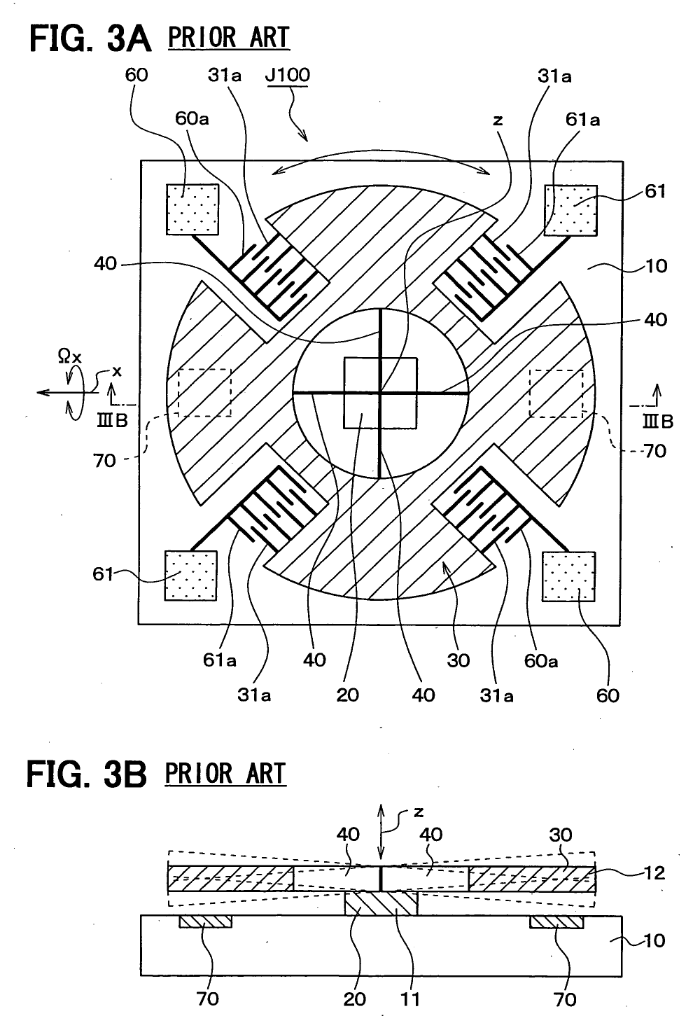

A second embodiment of the present invention will be described with reference to FIGS. 2A and 2B. The second embodiment 200 is similar to the first embodiment 100 described above, except that one more pair of second masses 32 is additionally provided to detect angular velocity Ωy around an axis y which is parallel to the plane of the substrate 10 and perpendicular to the detection axis x. In other words, in the second embodiment, the angular velocity Ωy around the axis y is detected in addition to the angular velocity Ωx around the axis x. The additional pair of second masses 32 is positioned along the axis y. All the second masses 32 are located in the cutouts of the first mass 31, the size of the angular velocity detector 200 is not enlarged because of the additional pair of the second masses 32.

When the angular velocity detector 200 is placed in an automobile so that the plane of the substrate 10 becomes horizontal and the direction y is in the driving direction, the pitching can be detected as the angular velocity Ωx and the rolling as the angular velocity Ωy. Similar advantages obtained in the first embodiment are attained in this second embodiment, too.

The present invention is not limited to the embodiments described above, but it may be variously modified. For example, though the second masses 32 are provided as a pair in the foregoing embodiments, the angular velocity around one axis can be detected by one second mass 32. Though the angular velocity detector is manufactured from a three-layer plate in the foregoing embodiments, it is possible to manufacture it from other raw materials. The shape of the inertial mass 30 including the first mass 31 and the second mass 32 can be variously modified as long as the above-mentioned functions are realized. Further, the shape of the driving beams 40 and the detecting beams 50 can be variously modified, as long as the driving beams 40 deform substantially in the rotational direction and the detecting beams 50 substantially in the axial direction. The shapes of the driving electrodes 60, 61, the stationary electrodes 60a, 61a and the movable electrodes 31a may be variously modified as long as they can give a proper rotational oscillation to the inertial mass 30. The angular velocity detector of the present invention may be used in various devices other than the automobile.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An angular velocity detector, comprising:
a substrate;
a support fixed to the substrate; and
an inertial mass supported by the support so that the inertial mass oscillates around a center axis that is perpendicular to a plane of the substrate, wherein:
the inertial mass comprises a first mass connected to the support via resilient driving beams and a second mass connected to the first mass via resilient detecting beams so that the second mass displaces in a direction parallel to the center axis upon imposition of an angular velocity around a detection axis that is perpendicular to the center axis when the inertial mass is oscillating around the center axis; and
the angular velocity around the detection axis is detected based on a displacement of the second mass relative to the plane of the substrate in the direction parallel to the center axis.

2. The angular velocity detector as in claim 1, wherein:
the second mass is composed of a pair of pieces positioned along the detection axis and symmetrically with respect to the center axis.

3. The angular velocity detector as in claim 2, wherein:
the second mass further includes a second pair of pieces positioned along a second detection axis, which is perpendicular to the detection axis and parallel to the plane of the substrate, and symmetrically with respect to the center axis; and
an angular velocity around the second detection axis is detected based on a displacement of the second pair of pieces relative to the plane of the substrate.
